(19) United States
(12) Patent Application Publication
(10) Pub. No.: US 2008/0278573 A1
(43) Pub. Date: Nov. 13, 2008

(54) Method and Arrangement for Monoscopically Representing at Least One Area of an Image on an Autostereoscopic Display Apparatus and Information Reproduction Unit Having Such an Arrangement

(75) Inventors: Timo Ropinski, Munster (DE); Frank Steinicke, Ohne (DE); Klaus Hinrichs, Munster (DE)

Correspondence Address: GUDRUN E. HUCKETT DRAUDT, SCHUBERTSTR. 15A, WUPPERTAL, 42289, DE

(73) Assignee: Westfalische Wilhems-Universitat Munster, Munster (DE)

(21) Appl. No.: 12/091,789

(22) PCT Filed: Nov. 14, 2006
(86) PCT No.: PCT/DE06/01994

§ 371 Date: Jul. 3, 2008

(30) Foreign Application Priority Data
Nov. 14, 2005 (DE) 10 2005 054 599.8
Jul. 5, 2006 (DE) 10 2006 030 990.1

(51) Int. Cl. H04N 13/04

(52) U.S. Cl. 348/51; 348/E13.001

(57) ABSTRACT

In a method for monoscopically representing at least one image area of an image on an autostereoscopic display apparatus with a resolution of M×N arranged like a matrix with M columns and N rows and a plurality of active or passive beam splitters or parallax barriers that separate the monitor pixels in P fields, an image area that is to be represented monoscopically is selected. A representation of the selected area is generated with a resolution of M/S×N/K image pixels wherein 1<S≦P and 1<K≦P and wherein each image pixel has assigned thereto a pixel value that on the display apparatus can be represented in color or black/white. The representation is transformed to the resolution M×N of the display apparatus and the transformed representation is read out into the display apparatus.

### TECHNICAL FIELD OF THE INVENTION

The invention relates to a method and an arrangement for monoscopically representing at least one area of an image on an autostereoscopic display apparatus having a resolution of M×N monitor pixels arranged like a matrix in M columns and N rowvs (M, N ∈ N₊, N₊=quantity of natural numbers greater 0) and a plurality of active or passive beam splitters or parallax barriers separating the monitor pixels into fields. The invention concerns also an information reproduction unit with such an arrangement.

### BACKGROUND OF THE INVENTION

The term “display apparatus” is to be understood generally as any type of display that is configured for representation of digital images and is comprised of a plurality of image elements referred to commonly as “monitor pixels”. They can be TV sets, computer monitors for one or several users but also displays of portable devices, for example, portable DVD players, mobile phones or portable computer games. The term “monitor pixel” serves in this context for differentiating the physically actually present elements of the display from the virtual image pixels of a digital image.

The term “image” is to be understood generally as information that can be represented on the display apparatus in a data-processing technological sense, i.e., a scene of a movie, an icon, a drawing, text and the like.

In particular, the images to be represented in this context are overlapping or adjacently arranged so-called windows with different contents that are to be displayed in front of a common background, generally the so-called desktop. In a window, for example, the window assigned to the running word processing program, information referred to in the following as “two-dimensional information”, for short “2-D information” such as e.g. a text can be displayed, and in another window three-dimensionally perceived images, in the following referred to as “three-dimensional information” or, for short, “3-D information”, for example; generated by a program for visualizing series of medica slice images, can be displayed.

The term “information reproduction device” refers to devices for visual representation of all kinds of information in which the inventive arrangement can be advantageously integrated, for example, navigation systems for vehicles, game consoles or mobile phones, PDAs and the like.

Autostereoscopic display apparatus of the kind in question in this context have a plurality of active or passive beam splitters or parallax barriers that separate the monitor pixels in such a way that at least two fields are produced of which one is intended for the left eye and the other for the right eye of a viewer of the display apparatus.

In this context it should be underscored that the term “field” not necessarily its to be understood as “half” an image, i.e., comprised e.g. of only half of the columns available on the employed display apparatus, but that said term is to be understood generally as one of two images that is intended for either the left eye or the right eye of the viewer and is to be supplemented to a stereoscopic image with the field intended for the other eye.

The aforementioned active or passive beam splitters or parallax barriers can be differently designed and, e.g. in the form of lenses, can separate groups of neighboring monitor pixels (lenticular grid technology as in so-called lenticular displays) or, in the form of barriers arranged vertically adjacent to one another; can separate monitor pixels of neighboring columns into P (P∈N₊, P≧2) fields (so-called vertical interiacing).

For a long time there has been the desire to represent images by means of two-dimensional display apparatus, for examples computer monitors or movie screens, in such a way that the viewer expenences a three-dimensional spatial impression. Since the spatial stereoscopic viewing is based on the left eye of a viewer providing an image to the brain of the viewer that is displaced by the spacing between the eyes relative to the image delivered to the brain by the right eye, wherein the two images are then combined by the brain to a spatial image, all stereoscopic imaging methods are based on generating at least two fields that belong to one another of one and the same scene wherein one field is intended for the right eye and the other filed for the left eye of the viewer.

In order to ensure that the fields reach the left or right eye of the viewer respectively, different methods are known that can be classified coarsely in regard to whether the fields are displayed at the same time or with temporal delay on the display apparatus, respectively.

A method is known from the early seventies in which fields are projected color-coded simultaneously onto a TV monitor or a movie screen and the viewers for separating the fields must wear glasses having in general a red and a green filters. As a result of various disadvantages and not the least the comical appearance of the glasses with red and green filters, this method however has never succeeded.

In particular for professional applications, for example, in the field of computer aided design (CAD) methods, employing time-delayed images, has found acceptance where the separation of the fields is realized in that the user must wear so-called “shutter glasses” that release, synchronous to the represented fields, the view through the left and right spectacle lens at a fast changing rate.

Since the change is carried out very fast (for example, 50 times per second), the continuous change is not realized by the user so that instead the brain of the user combines to a stereoscopic image the images received through the left and right spectacle lenses with delay, respectively.

Wearing such shutter glasses is however uncomfortable and particularly for persons that must already wear corrective glasses is possible only with increased expenditure so that therefore in the past few years increasingly possibilities have been explored to convey fields in different ways to the eyes of one or several viewers.

Great advances in the area of so-called flat screen displays, in particular liquid crystal, plasma and electroluminescence displays have made it possible that, by putting in front of the screen active or passive beam splitters or parallax barriers, two or several fields are generated at the same time so that for one or several viewers indeed a spatial effect results.

It can be provided for example that between two neighboring pixel columns a fixed or switchable parallax barrier is arranged such that the light of one monitor pixel reaches only the left eye and the light of a horizontally neighboring monitor pixel reaches only the right eye of the viewer. In this context, the so-called “3-D points” or “sweet spots” where the eyes of the viewer must be positioned with respect to the display in order to actually experience the full three-dimensional impression are very limited with regard to their spatial expansion so that already minimal deviations as they occur regularly when utilizing such a display (the head of the viewer in general is not fixed relative to the display) cause blurring of the three-dimensional impression.

Displays with beam splitters in which e.g. by means of lenses the fields displayed at the same time are conveyed to the right eye or left eyes of one or several viewers, respectively, have been found to be particularly advantageous. These displays enable, depending on the design of the employed beam splitter, to generate four or more fields in such a way that to the eyes of one or more viewers at the same time two fields can be correlated such that two or more viewers each can view a three-dimensional image; they make it possible also that the area, within which the eyes of the viewer must be positioned in order to be able to obtain the desired three-dimensional impression of the image displayed on the display, can be designed to be relatively large so that the viewer can move within limits freely in front of the monitor. In particular, such displays make it possible also to realize with relatively minimal expenditure a following action of these sweet spots such that a detection device evaluates continuously where the eyes of the viewer are relative to the monitor, for example, and the 3-D spots are then adjusted as a function of the recognized eye position.

A problem of the autostereoscopic display apparatus in which based on the physically present beam splitters automatically at least two fields are generated is that there are many applications for which a spatial representation is not desired or not provided for. For examples the task bars and certain text fields of computer programs are designed only for two-dimensional representation even in those computer programs that serve for generating three-dimensional images. When a two-dimensional image is represented in a conventional way on an autostereoscopic display apparatus a blurred image is generated for the viewer.

In stereoscopic displays with controllable parallax bamiers, this problem can be solved in that in the areas in which an image is represented only kno-dimensionally, such parallax barriers are switched off.

As a solution to the problem in regard to autostereoscopic displays with beam splitters DE 103 39 076 A1 proposes a focusing element in the form of a so-called sweet spot unit wherein the display comprises illumination elements and an information-carrying image matrix and the sweet spot unit is synchronized with the image matrix. This solution is however extremely complex with regard to optomechanical as well as electronic considerations.

### SUMMARY OF THE INVENTION

The invention has the object to provide a method and an arrangement for monoscopic representation of at least one area of an image on an autostereoscopic display apparatus that, even for simple autostereoscopic display apparatus with several parallax barriers or beam splitters, can be employed or retrofitted in a simple and inexpensive way so that with the corresponding autostereoscopic display device areas of images can also be displayed two-dimensionally.

In particular, the device should enable that, simultaneously, certain image areas are represented two-dimensionally and other image areas are represented three-dimensionally.

The invention is solved in regard to the method by a method for monoscopic representation of at least one image area of an image on an autostereoscopic display apparatus with a resolution of M×N monitor pixels arranged like a matrix in M columns and N rows (M, N∈N₊) and a plurality of active or passive beam splitters or parallax barriers that separate the monitor pixels in P (P∈N₊, P≧2) fields, in which method first at least one image area that is to be displayed monoscopically is selected, in which method subsequently a representation of the selected area with a resolution of M/S×N/K image pixels (S, K∈R, R=quantity of real numbers) is produced, wherein 1<S≦P and 1≦K≦P and wherein each image pixel has assigned thereto a pixel value that on the display apparatus can be represented In color or black/white, and in which method finally the representation is transformed to the resolution M×N of the display apparatus and is displayed on the display apparatus.

The invention is therefore essentially based on the idea to render the areas to be monoscopically represented on a virtual screen with lower resolution than the actual resolution of the autostereoscopic display apparatus and to then transform the information for this virtual screen to the full resolution so that a viewer will see images with the left eye and the right eye which images are very similar to one another or even identical so that for the viewer a two-dimensional impression results.

In an advantageous embodiment the representation of the selected area is rendered with a resolution of M/P×N/P, i.e. a resolution that is reduced with regard to columns and rows precisely by the number of fields to be generated. In this way, the rendered representation can be especially simply transformed to the resolution of the display apparatus and can be displayed such on the display apparatus that at two monitor pixels that participate in the illustration of the selected area and that positionally correspond to one another in two fields that belong together, the same pixel values are represented. In this respect, corresponding positionally means that for a viewer of the fields the pixels appear to originate from the same position or, in other words, a pixel that in the right field appears to have the coordinates x, y appears to have these same coordinates also in the left field.

This embodiment of the method has advantageously the effect that in two fields that belong together exactly the same “scene” is represented in selected areas; this causes the viewer to experience a two-dimensional impression.

In this context, it should be noted that an image pixel usually has assigned an m-dimensional vector, the so-called pixel value (m∈N₊) whose individual compnonents match intensity levels of usually three or four monitor subpixels wherein these subpixels form a monitor pixel. For a color display with a resolution of e.g. 800×600 pixels, depending on the type of display, there are actually 3 (or 4)×800×600 individually controllable pixels that enable the color representation of an image.

The “pixel value” can thus be, in case of black-and-white illustration, actually an individual scalar value of a predefined value range (then usually referred to as grayscale) and e.g. can have integer values between 0 and 256; the pixel value can also be e.g. a three-dimensional or four-dimensional vector. For the aforementioned advantageous embodiment this however plays no role because in case of e.g. a four-dimensional vector according to the invention all four components of a pixel of the generated representation are represented in two monitor pixels that positionally correspond to one another in fields that belong together.

When the selected image area is, for example, a text, this text is experienced by the viewer in the end in such a way as if it were printed in a conventional way on paper or as if it were displayed on a conventional non-autostereoscopic monitor.

Even though in most applications P=2, i.e., the beam splitter or parallax barriers generate only two fields, the invention is not limited to P=2. When, for example, a display apparatus with a beam splitter is used that generates four fields, it can be that, depending on the design of the corresponding display apparatus, the pixels that positionally correspond to one another in two fields that belong together are not physically immediately neighboring one another on the display apparatus but are separated by a gap in which pixels of a further field are represented.

When the autostereoscopic display apparatus used for performing the method is a display with vertical beam splitters for generating two fields, the two pixels that positionally correspond to one another in the fields can be generated actually by two vertical monitor pixels that neighbor one another immediately horizontally.

In the aforementioned application in which precisely two fields are generated, the resolution in the image area that is to be represented two-dimensionally can be reduced to one-fourth of the actually possible resolution based purely on the physical number of monitor pixels and then is transformed back to the actual resolution of the display apparatus in order to prevent that accordingly also the length and width of the selected area of an image has only half the actual size.

In this context it should be underscored that depending on the application environment of the method it must not be necessary to also reduce the line resolution of the two-dimensional image areas to be generated. It is possible, for example, to generate a resolution of the 800×1,200 pixels from an image that is to be represented two-dimensionally on an autostereoscopic display apparatus having a resolution of 1,600×1,200 pixels (arranged in 1,600 columns and 1,200 rows). The person skilled in the art therefore advantageously can select an optimally adjusted resolution for the representation that is matched to the respective application environment. Because many programs and operating systems are already designed for monitors with resolutions of 1,600×1,200 and 800×600, methods can be realized especially easily in which the row-related resolution is reduced in particular by the same factor as the column-related resolution.

Even though for many applications it can be advantageous to select the scaling factors S and K, by which the resolution is reduced for generating the representation of the image areas to be represented two-dimensionally, such that at least S=P (number of the fields to be produced), it has been found surprisingly that excellent results, acceptable for the viewer, can also be achieved when 1<S<P in particular when (0.75×P)<S<P. In this case, the transformation of representation to the resolution M×N of the display apparatus and reading out of the transformed representation into the display apparatus can be realized by using interpolation, in particular a bi-linear interpolation or bi-cubic interpolation.

In this advantageous embodiment the viewer views two slightly different images in the “two-dimensional area” while the two fields for the left eye and the right eye can be identical for S=P. The viewer views the corresponding image not quite as sharp but advantageously more information can be displayed on the same real screen surface: when the autostereoscopic display apparatus has, for example, a resolution of 1,600×1,200 pixels and when S=K=P=2, two-dimensional text information can therefore be rendered on a virtual screen with a resolution of 800×600 pixels which can have the effect that the information surpasses the window size, because usually each letter or icon has assigned a certain minimal size, and automatically so-called scrolling or moving bars (usually referred to as scroll bar) are generated along the edges of the window with which the user then can move the window essentially to the left/right or up/down in order to be able to display also the remaining information (usually the window does not move but the information represented in the window is moved to the left/right or up/down). Of course, such additional operations slow down reading of a text. When however S and K are e.g selected to be 1.56, in the aforementioned example the representation can be generated with a resolution of 1,024×768 which may be sufficient to represent the information without scroll bars. When the representation is then transformed to the actual resolution of 1,600×1,200 in particular by applying a bilinear or bi-cubic interpolation, in the aforementioned example (with P=2) two slightly different fields containing essentially information that is to be represented two-dimensionally will result; this is perceived by most viewers as an excellent compromise between readability and clarity on the one hand and simpler and faster operation (without scrollbar actuation) on the other hand.

In a preferred embodiment it is provided that at least one image area that is to be represented monoscopically is selected automatically. This makes it possible that, for example, certain parts of a screen display generated e.g. by a computer, for example, the usual so-called tool bar, can be automatically represented two-dimensionally on the autostereoscopic display apparatus.

Alternatively or additionally, it can also be provided that the user can define manually, for example, by means of a pointer device such as a mouse, a track ball, a touch pad, or touchscreen which image areas are to be displayed monoscopically and which image areas are to be displayed stereoscopically. This makes utilization particularly comfortable because since the so-called window technology has found general acceptance each user has certain habits with regard to arranging the individual program windows on his so-called “desktop”, i.e., on the visible surface of the display device. While some users prefer that a program fills the entire representation area when working with the program, other users prefer that certain parts of the desktop, for example, certain program icons, are always visible.

In a further preferred embodiment of the method in which the image displayed on the display apparatus is continuously newly generated by a data processing unit, for example, a computer, it is provided that certain elements of the image that can be generated are assigned priority features in such a way that, when an element is to be generated, the image area in which the element is to be represented is monoscopically represented independent of a manual and/or automatic selection. For example, this enables to generate on the autostereoscopic display apparatus hvo-dimensionally certain alarm, error or notification messages, for example, “low battery” or “you have new e-mails”, that are generally generated by a program or directly by the operating system with high priority relative to other programs but are usually not designed for three-dimensional representation, without the user having to define beforehand a certain area of the image. The same holds true also for so-called pulldown and context menus.

In this context, the selected image area or image areas must not be rectangular but can have instead any desired shape. That something has a resolution of M×N pixels is not to be understood to mean that for its representation only precisely M×N pixels must be used. For example, it is possible that a selected area that is to be two-dimensionally represented on the autostereoscopic display apparatus has an L-shape, the shape of a surrounding frame, or any other shape.

As a function of the type of the information in the image area that is to be represented monoscopically, when generating the representation with the resolution that is reduced relative to the physically possible resolution of the display apparatus and/or for the transformation of this representation to the resolution of M×N image pixels, it can be provided that certain image improvement operations for example, so-called “opening and closing operations” are performed.

With regard to the arrangement, the aforementioned object is solved by an arrangement for monoscopic representation of at least one image area of an image, wherein the arrangement comprises an autostereoscopic display apparatus with M×N monitor pixels arranged like a matrix in M columns and N rows, a plurality of active or passive beam splitters or parallax barriers that separate the monitor pixels into P (P∈N₊, P≧2) fields, and a data processing unit coupled to the display apparatus, wherein the data processing unit produces control signals for controlling the monitor pixels and wherein the arrangement furthermore comprises means for selecting the image area that is to be displayed monoscopically, wherein means for generating a representation of the selected area with a resolution of MIS×N/S image pixels (S, K∈R) are provided, wherein 1<S≦P and 1≦K≦P and wherein each image pixel has assigned a pixel value (usually as described above m-dimensional) that can be represented on the display apparatus in color or black/white and wherein furthermore means for transforming the representation to the resolution M×N of the display apparatus and reading out the transformed representation into the display apparatus are provided.

The arrangement can be easily realized also with already existing display devices. In this connection, in particular the exchange of already existing hardware is advantageously not needed because the described means can be realized also by software by utilizing the usually existing hardware.

For S=P and optionally also K=P the means for transforming the representation to the resolution M×N of the display apparatus and reading of the transformed representation into the display apparatus can be configured such that in two monitor pixels, respectively, that are participating in the representation of the selected area and that positionally correspond to one another in two fields that belong together, the same pixel values are represented.

In a preferred embodiment in which the active or passive beam splitters or parallax barriers are arranged vertically adjacent to one another and separate the monitor pixels of neighboring columns into P (P∈N₊, P≧2) fields, it is provided that the same pixel values are represented in two monitor pixels of neighboring columns, that participate in the representation of the selected area.

As described above, it may also be that 1<S<P and optionally also S=K. It is than advantageous when the means for transforming the representation to the resolution M×N of the display apparatus and reading out the transformed representation into the display apparatus also comprise means for executing interpolation, in particular, a bi-linear or bi-cubic interpolation.

The means for selecting the image area or image areas that are to be represented monoscopically, can comprise user-operated pointer devices such as in particular a mouse, a trackball, a touchpad and/or a touchscreen.

The arrangement can comprise a first frame buffer having a resolution of M×N image pixels and a second frame buffer having a resolution of M/S×N/K image pixels. In this context, means for reading the second frame buffer into the first frame buffer can be provided.

For certain applications it can be advantageous to provide that the means for transforming the representation to the resolution M×N of the display device and for reading out the transformed representation into the display device have means for performing image improvement operations such as, in particular, opening/dosing operations, in order to perform such operations, depending on the type of information in the image area that is to be represented monoscopically, for generating the representation with the resolution of M/S×N/K image pixels, and/or for the transformation of this representation to the resolution of M×N image pixels.

The invention concerns also an information reproduction unit, as e.g. especially a navigation system, a game console, a PDA (personal digital assistant), mobile phone, or the like, with an arrangement according to the invention. For such an information reproduction unit, in particular a navigation system, it can be provided that P is an odd number, in particular 3, and that the display apparatus is designed for simultaneous representation of stereoscopic images, in particular navigation information, for a first viewer and monoscopic images, in particular a movie or a TV program, for a second viewer.

The invention further concerns also a computer program product in particular, a driver or an operating system, for realizing a method according to the invention.

Further details and advantages of the invention result from the following purely exemplary and non-limiting description of two embodiments in connection with the drawing.

### BRIEF DESCRIPTION OF THE DRAWINGS

FIG. 1 illustrates schematically a possible arrangement for monoscopic representation of at least one image area of an image on an autostereoscopic display apparatus.

FIG. 2 illustrates a schematic of a first possible embodiment of the method according to the invention.

FIG. 3 illustrates a schematic of a second possible embodiment of the method according to the invention,

### DESCRIPTION OF PREFERRED EMBODIMENTS

In the following preferred embodiments of the invention will be described purely in an exemplary fashion and in a non-limiting way with reference to the drawings.

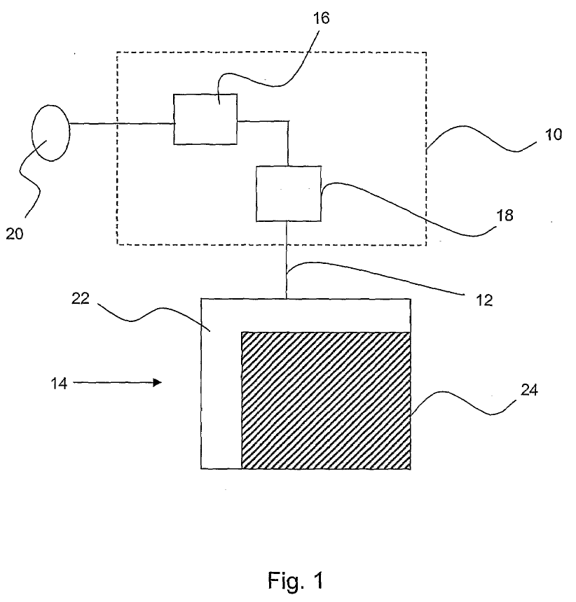

FIG. 1 shows a data processing unit referenced as a whole by 10, for example, in the form of a commercially available computer that is coupled by data line means 12 to the autostereoscopic display apparatus referenced as a whole by 14.

The data processing unit 10 comprises in this embodiment a central processing unit 16 and a separate image generating unit 18, for example, in the form of a graphics card. The data processing unit moreover comprises a pointer device 20, for example, in the form of a mouse, with which a user can mark areas of the display apparatus in which 2-D information and areas in which 3-D information are to be represented.

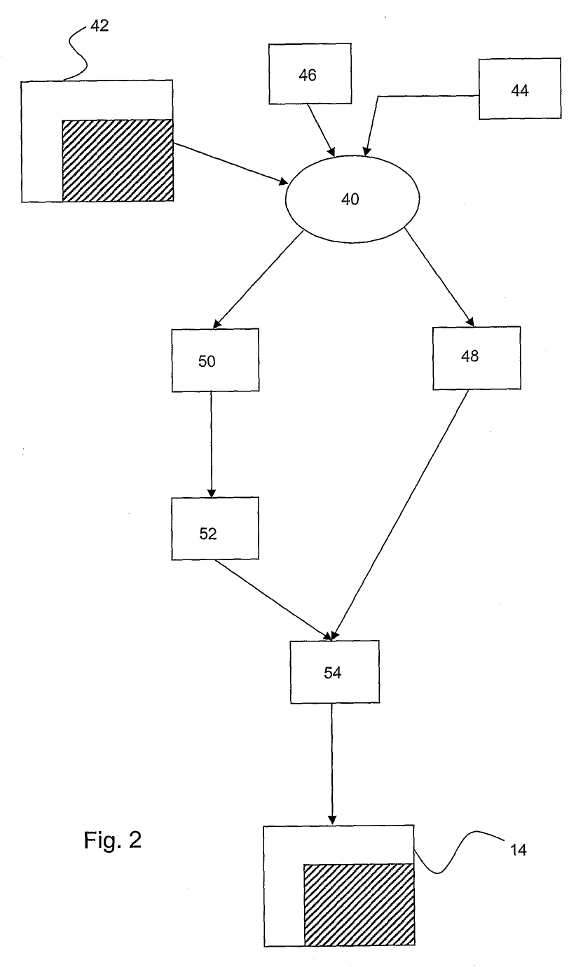

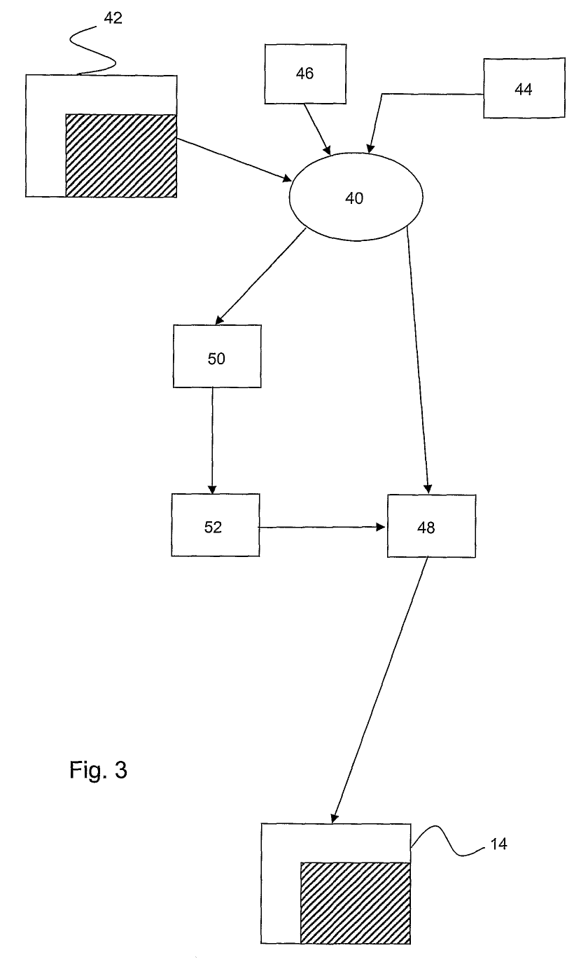

The graphics card controls by means of data line means 12 the display apparatus 14 in such a way that a certain area 22 of the display apparatus represents images monoscopically and in another area, indicated here as a crosshatched area 24, represents images stereoscopically. This can be realized in different ways as will be explained in more detail in the following with reference to FIGS. 2 and 3.

FIG. 2 shows a schematic of a possible embodiment of the inventive method for generating monoscopic images or image areas on a stereoscopic display apparatus. In this context, the following approach can be used: automatically or manually, for example, by means of the aforementioned mouse or another suitable pointer device, a screen division 42 is supplied to an image generating unit 40, that for purposes of this application is to be considered a “black box”, in such a way that the image generating unit can save in which area or which areas (in this context the area that is not crosshatched) of the screen two-dimensional and in which area or areas (here the crosshatched area) three-dimensional images are to be represented.

Appropriate three-dimensional images can be generated by a 3-D application 44 running on the computer, for example, a CAD program, a game, a program for representing and evaluating medical image data and the like, and can be supplied to the image generating unit 40.

Two-dimensional images, for example, can originate from a 2-D application 46 such as a word processing program or the operating system of a computer and can comprise e.g. the so-called task bar or parts of the 3-D application 44 itself, for example, a corresponding tool bar with different menus for operating the 3-D application that are to be represented two-dimensionally.

The image generating unit 40 differentiates whether the incoming image information is to be represented on the 3-D area or the 2-D area of the screen. The information for the three-dimensional area are written into a frame buffer 48 that has a resolution of M×N pixels corresponding to the resolution of M×N monitor pixels of the display apparatus 14.

It should be mentioned in this context that not all 3-D applications already provide image information that is suitable for representation on an autostereoscopic display apparatus. In this case it can be provided that the image information is subjected to an appropriate processing method for generating autostereoscopically representable image data, in particular e.g. along the path from the 3-D application 44 to the image generating unit 40 it is subjected to a function call tracing or along the path of the image generating unit 40 to the frame buffer 48 it is subjected to image warping.

The information for the 2-D area is written into a frame buffer 50 that in this embodiment, in which the display device has a simple beam splitter for generating two fields, has a resolution of M/2×N/2 pixels. As described above, the frame buffer could have a higher resolution, for example, a resolution of M/1.5625×N/1.5625 pixels.

In the next processing step the information saved in the frame buffer 50 in this embodiment is essentially “quadrupled” and read into a frame buffer 52 that has a resolution of M×N pixels wherein the method can be simply carried out such that the pixel values at the image pixels with the coordinates m, n (m, n∈N₊) of the frame buffer 50 are written into the image pixels with the coordinates (2m−1, 2n−1) (2m, 2n−1), (2m−1, 2n) and (2m, 2n) of the frame buffer 52. Pixel values in the image pixel with the coordinates (m+1, n+1) of the frame buffer 50 would then be written into the image pixels with the coordinates (2m+1, 2n+1) (2m+2, 2n+1), (2m+1, 2n+2) and (2m+2, 2n+2) of the frame buffer 52 etc.

It should be underscored in this context that instead of this simple quadruplication of the corresponding pixel values it can also be provided that certain image improvement operations are carried out in the step of transformation from the resolution M/2×N/2 to the resolution M×N; this has e.g. the effect that certain sharp edges (hard black/white contrast) are smoothed by insertion of interpolated grayscale values. In this connection, the person skilled in the art can select advantageously the optimal configuration for a specific application situation. When the frame buffer 50 has a resolution of, for example, M/1.5625×N/1×1.5625 pixels, advantageously an interpolation, in particular bi-linear or bi-cubic interpolation, can be performed in order to represent the image of M/1.5625×N1×1.5625 resolution on the screen with the M×N resolution. In the simplest embodiment, the pixel values are written from the frame buffer 50 into four pixels of the frame buffer 52, respectively.

The frame buffers 48 and 52 are then read out into a common frame buffer 54 with resolution M×N in such a way that the aforementioned defined image areas are written with 2-D information and 3-D information. The frame buffer 54 is then finally read out and represented on the display apparatus 14.

In another modified embodiment whose flow chart is illustrated in FIG. 3 a third frame buffer is not necessary because the frame buffer 52 is read out directly into the frame buffer 48 in such a way that the 3-D information contained in the frame buffer 58 is not overwritten. The frame buffer 48 can then be directly read out into the display apparatus 14. For the person skilled in the art, it is apparent that other configurations are possible, for example, the frame buffer 48 is read out into the frame buffer 52 which is then read out into the display apparatus 14. Also, for an appropriate computing output it is conceivable to utilize only two or even only one frame buffer.

Within the scope of the inventive concept, numerous modifications and developments are possible that, for example, relate to the selection of image areas to be represented two-dimensionally. In particular, an automatic adjustment of these areas can be provided in such a way that upon clicking on a menu icon opening of a context menu in a 2-D area the menu will open and information in the 3-D area is overwritten with 2-D information so that the menu items that are usually represented by two-dimensional text are easy to read. Also, the invention can be used for so-called multiuser displays wherein, for example, six fields for three users are generated.

What is claimed is:

1. Method for monoscopically representing at least one image area of an image on an autostereoscopic display apparatus with a resolution of M×N arranged like a matrix with M columns and N rows (M, N∈N₊) and a plurality of active or passive beam splitters or parallax barriers that separate the monitor pixels in P (P∈N₊, P≧2) fields,
comprising the steps of:
selecting the image area that is to be represented monoscopically;
generating a representation of the selected area with a resolution of M/S×N/K image pixels (S, K∈R), wherein 1<S≦P and 1≦K≦P and wherein each image pixel has assigned thereto a pixel value that on the display apparatus can be represented in color or black/white,
transforming the representation to the resolution M x N of the display apparatus and reading out the transformed representation into the display apparatus.

2. Method according to claim 1, characterized in that S=P and preferably K=P are selected and that the transformation of the representation to the resolution M×N of the display apparatus and reading out the transformed representation into the display apparatus is realized such that the same pixel values are represented in two monitor pixels that are participating in the representation of the selected area and that positionally correspond to one another in two fields that belong together.

3. Method according to claim 1, wherein the autostereoscopic display apparatus has a plurality of vertically adjacently arranged active or passive beam splitters or parallax barriers separating the monitor pixels of neighboring columns into two fields, characterized in that for representing the selected area in two monitor pixels of neighboring columns the same pixel values are represented, respectively.

4. Method according to claim 1, characterized in that S=K=P.

5. Method according to claim 1, wherein at least 1<S<P and optionally also S=K, characterized in that the transformation of the representation to the resolution M×N of the display apparatus and reading out the transformed representation into the display apparatus is realized by application of an interpolation, in particular, a bi-linear or bi-cubic interpolation.

6. Method according to claim 1, characterized in that 1<S<P and preferably K=S, in particular (0.75×P)<S<P.

7. Method according to claim 1, characterized in that at least one image area that is to be represented monoscopically is selected automatically and in particular comprises an operating bar of a computer program.

8. Method according to claim 1, characterized in that at least one image area that is to be represented monoscopically is manually selected by a user.

9. Method according to claim 1, wherein the image represented on the display apparatus is generated continuously anew by a data processing unit, characterized in that priority features are assigned to certain generatable elements of the image such that, when such an element is to be generated, the image area in which the element is to be represented is monoscopically represented independent of a manual and/or automatic selection.

10. Method according to claim 1, characterized in that depending on the kind of information in the image area that is to be represented monoscopically, image improvement operations, for example, opening/closing operations, are performed when generating the representation with the resolution of M/S×N/K image pixels and/or transforming this representation to the resolution of M×N image pixels.

11. Method according to claim 1, wherein at least one image area of an image generated by a data processing unit is to be displayed stereoscopically and an image area of the image is to be displayed monoscopically on the autostereoscopic display apparatus, characterized in that
a representation of the image area that is to be represented stereoscopically is written into a first frame buffer with a resolution of M×N image pixels,
a representation of the image area that is to be represented monoscopically is written into a second frame buffer with a resolution of M/S×N/K image pixels,
the representation that is written into the second frame buffer is transformed to a resolution of M×N and together with the representation written into the first frame buffer, optionally with interconnection of a further frame buffer or several further frame buffers, is read out into the display apparatus.

12. Arrangement for monoscopically representing at least one image area of an image, comprising:
an autostereoscopic display apparatus with M x N monitor pixels (M, N∈N₊) arranged like a matrix in M columns and N rows and a plurality of active or passive beam splitters or parallax barriers separating the monitor pixels into P (P∈N₊, P≧2) fields, and
a data processing unit coupled to the display apparatus wherein the data processing unit generates control signals for controlling the monitor pixels,
characterized in that
means for selecting the image area that is to be monoscopically represented are provided,
means for generating a representation of the selected area with a resolution of M/S×N/K image pixels, (S, K∈R), wherein 1<S≦P and 1≦K≦P and wherein a pixel value that can be represented on the display apparatus in color or black/white, are provided,
means for transforming the representation to the resolution M×N of the display apparatus and reading out the transformed representation into the display apparatus are provided.

13. Arrangement according to claim 12, in which S=P and preferably K=P, characterized in that the means for transforming the representation to the resolution M×N of the display apparatus and reading out the transformed representation into the display apparatus are designed such that the same pixel values are represented in two monitor pixels that are participating in the representation of the selected area and positionally correspond to one another in two fields that belong together.

14. Arrangement according to claim 12, wherein the active or passive beam splitters or parallax barriers are arranged vertically adjacent to one another and separate the monitor pixels of neighboring columns into P (P∈N₊, P≧2) fields, characterized in that the same pixel values are represented in two monitor pixels of neighboring columns, respectively, that participate in the representation of the selected area.

15. Arrangement according to claim 12, wherein at least 1<S<P and optionally also S=K, characterized in that the means for transforming the representation to the resolution M×N of the display apparatus and for reading out the transformed representation into the display apparatus comprise means for carrying out an interpolation, in particular, a bi-linear or bi-cubic interpolation.

16. Arrangement according to claim 12, characterized in that the means for selecting the image area or image areas to be represented monoscopically comprise user-operated pointer devices such as in particular a mouse, a trackball, a touchpad, and/or a touchscreen.

17. Arrangement according to claim 12, characterized in that a first frame buffer with a resolution of M×N image pixels and a second frame buffer with a resolution of M/S×N/K image pixels are provided.

18. Arrangement according to claim 17, characterized in that means for reading out the second frame buffer into the first frame buffer are provided.

19. Arrangement according to claim 12, characterized in that the means for transforming the representation to the resolution M×N of the display apparatus and for reading out the transformed representation into the display apparatus comprise means for carrying out image improvement operations, such as in particular openingiclosing operations, in order to carry out such operations, dependent on the type of information in the image area that is to be represented monoscopically, when generating the representation with the resolution of M/S×N/K image pixels and/or when transforming this representation to the resolution of M×N image pixels.

20. Information representation unit such as a navigation system, PDA, mobile phone, game console or the like, comprising an arrangement according to claim 1.

21. Information representation device, in particular navigation system, according to claim 21, characterized in that P is an odd number, in particular 3, and that the display apparatus is configured for simultaneous representation of stereoscopic images, in particular navigation information, for a first viewer and monoscopic images, in particular a movie or a TV program, for a second viewer.

22. Computer program product, in particular driver or operating system for realizing a method according to claim 1.
